(19) United States
(12) Patent Application Publication
(10) Pub. No.: US 2026/0146912 A1
(43) Pub. Date: May 28, 2026

(54) SENSOR DATA COMPRESSION FOR EFFICIENT DATA TRANSFER

(71) Applicant: Tractian Technologies Inc, Atlanta, GA (US)

(72) Inventors: Edgar Felipe Sierra Alonso, Ibague (CO); João Pedro de Carvalho Voltani, São Paulo (BR)

(21) Appl. No.: 19/379,122

(22) Filed: Nov. 4, 2025

Related U.S. Application Data
(60) Provisional application No. 63/724,067, filed on Nov. 22, 2024.

(51) Int. Cl. G01M 7/02; G01P 15/18

(52) U.S. Cl. CPC G01M 7/025; G01P 15/18

(57) ABSTRACT

A maintenance monitoring and recommendation infrastructure can include a plurality of monitors, which can be attached to various industrial equipment. The monitors can include a plurality of sensors and wireless communication circuitry to transmit the sensor data to a receiver. The receiver can be connected to the maintenance monitoring infrastructure, where the sensor data can be used to perform maintenance data analysis and provide artificial-intelligence-based maintenance recommendations. The monitors can compress sensor data to improve the efficiency of transport, while maintaining improved battery life. The compression can be based on a feedback from the machine learning algorithms to determine frequencies of the regions of interest (ROIs) in the sensor data, which are more relevant to failure analysis. The more relevant ROIs are compressed less aggressively, while other regions are compressed more aggressively.

### CROSS-REFERENCE TO RELATED APPLICATIONS

This application claims the benefit of priority to U.S. Provisional Application No. 63/724,067, filed on Nov. 22, 2024, which is hereby incorporated by reference in its entirety.

### BACKGROUND

### Field

This invention relates generally to the field of wireless communication and more particularly to low-power wireless data transfer between battery-powered devices and one or more base stations.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Industrial plants can include numerous mechanical machines with thousands of moving parts. To increase the efficiency of plant operations, the machines are monitored for maintenance purposes. Monitoring can include a trained technician visually inspecting the machines, observing the machine operations, and listening for any abnormal auditory cues that can indicate a present or potential maintenance-related fault in the machines. The technicians can also perform more sophisticated diagnosis, using maintenance and diagnostic tools. Continuous monitoring of industrial machines can present operational inefficiencies and cost to an industrial plant, particularly as the number of machines can be substantial in an industrial plant. For these and similar reasons, plants or busy shops with mechanical machines can benefit from an automated maintenance infrastructure. The automatic maintenance infrastructure can continuously collect maintenance-related data from various machines, detect maintenance-related events, and recommend appropriate action.

An automatic maintenance infrastructure can take advantage of monitors and receivers that are equipped with wireless communication technology. Since the monitors in some or many cases can be battery-powered, there is a need for a robust communication technology, which can reliably transmit data payloads between the monitors and receivers, while preserving the battery life of the monitors.

In many cases, the sensor data can be voluminous. Transferring a substantial amount of sensor data can negatively impact the life-expectancy of the monitors in an automatic maintenance infrastructure. At the same time, the effectiveness of the automatic maintenance infrastructure can be negatively impacted if the monitors do not sample data as frequently or do not transmit data in sufficient quantity and quality to facilitate maintenance and failure analysis. Therefore, there is a need for techniques that allow the monitors to robustly sample and transmit sensor data, while improving the battery life and life-expectancy of the monitors, compared to traditional technology.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1A illustrates example diagrams of a monitor, industrial machines, and an infrastructure of fault monitoring and maintenance operations according to some embodiments.

FIG. 1B illustrates an exploded view of the monitor of the embodiment of FIG. 1A.

FIG. 2 illustrates a spectrum graph of the magnitude of a sample vibration signal, plotted against frequency.

FIG. 3 illustrates a graph of a magnitude spectrum of a vibration signal in the shaft speed region, comparing the decompressed version of the vibration signal to its original vibration signal in the shaft speed region.

FIG. 4 illustrates a graph of a magnitude spectrum of a vibration signal in the kurtosis region, comparing the decompressed version of the vibration signal to its original vibration signal in the kurtosis region.

FIG. 5 illustrates a graph of a magnitude spectrum of a vibration signal in the remainder region, comparing the decompressed version of the vibration signal to its original vibration signal in the remainder region.

FIG. 6 illustrates an example block diagram of a codec that implements a compression technique, according to some embodiments.

FIG. 7 illustrates an example block diagram of a compression module, according to an embodiment.

FIG. 8 illustrates an example flowchart of a compression method, according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Industrial machines can benefit from consistent and accurate fault monitoring with artificial intelligence processing of the monitored data. In some embodiments, a plurality of small monitor assemblies, each equipped with wireless communication circuitry can be attached to various industrial machines in a plant. The monitors can sense and report various operational parameters related to fault monitoring. For example, temperature and vibration can be monitored and reported. The quality of vibrations, vibration trend data and other characteristics can be indicators of fault occurring or developing in an industrial machine. Similarly, temperature and temperature trends of a machine can include indicators of occurring or upcoming faults in the machine.

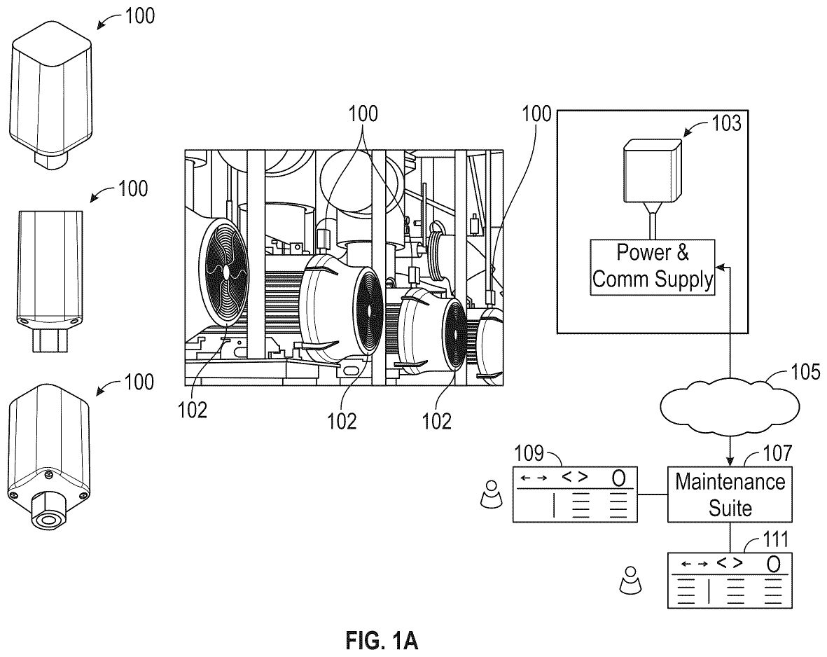

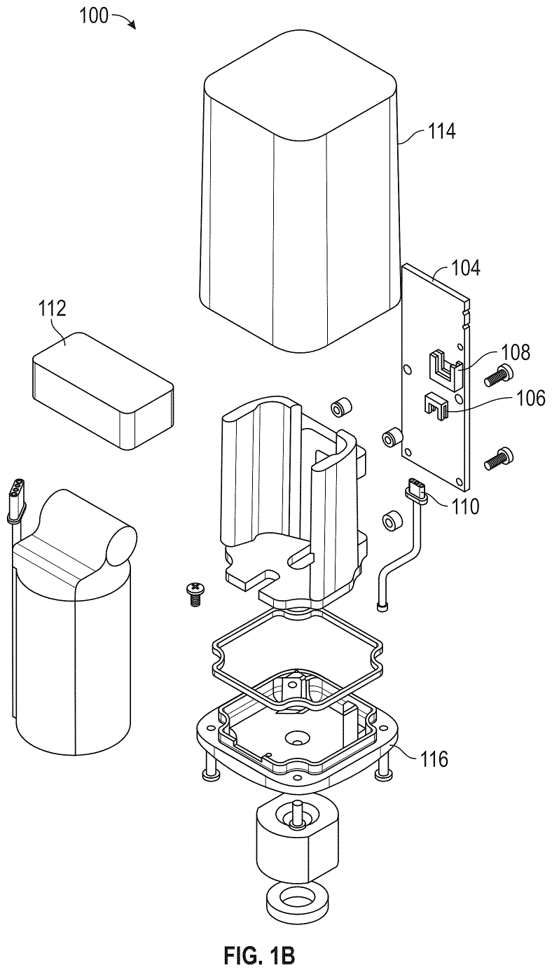

FIG. 1A illustrates example diagrams of a monitor 100, industrial machines 102, and an infrastructure of fault monitoring and maintenance operations according to some embodiments. The monitor 100 can be battery operated and can include a variety of sensing components enclosed in a housing. The monitor 100 can attach to machines 102 in the plant using a magnetic connection and/or by using other methods of attachment and fastening to secure the monitors 100 to machines 102 in the plant. The attachment of the monitors 100 to machines 102 can depend on the magnitude of the vibrations and other considerations related to the environment of the machines 102 and the plant. For example, if larger magnitude vibrations are expected, the connection between the monitors 100 and the machines 102 can be secured with an adhesive agent, so the monitors 100 can maintain their connections to the machines 102, despite large vibrations.

The monitors 100 can include wireless communication circuitry and can be in wireless communication with one or more receivers 103. In some embodiments, one or more monitors 100 can be modified to be in wired communication with a receiver 103 and have a connection to an outlet source of power. In other words, the source of power and type of communication of the monitors 100 can be modified, depending on the application and the environment of the plant to include any combination of battery-operated, outlet-operated, wired communication, and wireless communication. Similarly, the receivers 103 can include both wired and wireless communication circuitry. The receivers 103 can also be powered with or without the use of a battery. In some embodiments, both the monitors 100 and the receivers 103 can wirelessly communicate to a portable computer, such as a laptop, a smart phone, a smart tablet, or other portable devices, in the field, using a local or cellular wireless network. Although the term receiver is used, the receivers can also send data to monitors 100. Consequently, receivers 103 can be transceiver devices. For example, a receiver 103 can send a configuration file to a monitor 100 to enable, disable or otherwise configure various operating parameters of the monitor 100.

Both monitors 100 and receivers 103 can include processing and communication circuitry. For example, both monitors 100 and receivers 103 can include microprocessors, permanent and impermanent memory devices, and transceivers or equivalent devices. Monitors 100 and receivers 103 can perform various data processing when transmitting and/or receiving sensor data, and/or instructions and specifications data, related to their respective operations.

The numbers and locations of the receivers 103 can depend on the size of the plant and then numbers and distances of the monitors 100, relative to the receiver 103 and the wireless communication technology used to communicate between the monitors 100 and the receiver 103. The receivers 103 can be mounted at various locations in a plant and can have connection to a power and a communication source. For example, the receivers 103 in a plant can be in wired and/or wireless communication to one or more communication portals 105. Example communication portals 105 can include a local network, the Internet, one or more cloud infrastructures, gateways, other receivers 105, and other communication midpoints, or endpoints. The receivers 103 can transmit the fault monitoring data for upstream processing. The receivers 103 can also receive various operational configuration files, settings files, and/or other operating parameters and can transmit the operating parameters to the monitors 100. Examples operating parameters can include various timing and frequency of when and how the monitors 100 should collect data from the machines 102.

A maintenance suit 107 can receive monitoring data from the monitors 100 and perform processing related to fault monitoring and maintenance operations on the data. The maintenance suite 107 can include a variety of submodules and databases that can support processing of the monitoring data, including, storage of the data, generating reports from the data, extracting trends from the data, generating fault prediction from the data, generating maintenance action items, tickets, generating alerts, and/or other automated actions related to the maintenance of the machines 102. In some embodiments, the operations of the maintenance suite 107 can include artificial-intelligence submodules that can assist in fault prediction, maintenance recommendation pattern and trend detection, and other data analytics action, augmented or generated by artificial intelligence models. Example artificial intelligence techniques and/or models used by maintenance suite 107 can include neural networks, deep neural networks, machine learning, convolutional neural networks (CNNs), random forests, and others.

The maintenance suite 107 can support a variety of user interfaces (UIs). For example, the maintenance suite 107 can support a frontend user interface 109 and a backend user interface 111. Various parameters related to the operation of the monitors 100 can be viewed and/or modified via the user interfaces 109, 111. The user interfaces 109, 111 can provide access for a user to generate or modify configuration files, settings and operating parameters for the monitors 100 and the maintenance suite 107. The users can also view the output of the maintenance suite 107 via the user interfaces 109, 111.

While not shown, the monitors 100 are not the only maintenance-related in-field components operated by the maintenance suite 107. Other components associated with monitoring and maintenance of the machines 102 and the plant can also be in communication with the maintenance suite 107. For example, in some embodiments, energy management components in communication with the maintenance suite 107, can monitor the power consumption of the machines 102 and their plant.

Depending on the size of an industrial plant, the monitors 100 can be numerous, for example in the hundreds or thousands. The maintenance suite 107 can streamline and track data from hundreds or thousands of machines and automate the identification and tracking of maintenance-related tasks for a large industrial plant, having hundreds or thousands of machines.

FIG. 1B illustrates an exploded view of a monitor 100. Some example components include the printed circuit board (PCB) 104, the microcontroller 106, an accelerometer 108, a temperature sensor 110, a battery module 112, various spacers, holders, internal conduits, and a housing 114. The housing 114 can house the internal components of the monitor 100. A housing lid 116 can enclose the housing 114 and seal the internal components of the monitor 100 from the outside. The monitor 100 can be made water-, dust- and particle-resistant by a variety of techniques. For example, in some implementations, the monitor 100 can be resin-coated. The battery module 112 can include one or more lithium-ion batteries, and a battery management system (BMS). In other embodiments, the BMS can be external to the battery module 112, for example, it can be mounted on the PCB 104. In some embodiments, the life expectancy of the battery module 112 can be between three to five years. In some embodiments, the monitor 100 can be manufactured using application-specific integrated circuit (ASIC) technology, in lieu of or in addition to using a PCB technology.

The monitor 100 can include communication circuitry, corresponding to the communication circuitry of one or more receivers, for example, the receivers 103, and one or more local, private and/or public communication network, including one or more cellular networks. The choice of network and communication circuitry can depend on the size of the plant and the distance of the monitor 100 from a receiver 103. The communication circuitry of the monitor 100 can be mounted on the PCB 104. In some embodiments, the communication circuitry may be integrated in the microcontroller 106. Similarly, in other embodiments, various components can be combined into one or use a component that integrates several components together. On the other hand, some components, for example, the communication circuitry of the monitor 100, can be a separate module, embedded on the PCB 104, or otherwise separately included in the monitor 100. In some embodiments, the communication circuitry of the monitor 100 can include a transceiver, as an independent component, or as an internal component of another component, such as the microcontroller 106. The microcontroller 106 can alternatively be referred to as a microprocessor. The monitor 100 can include a magnetic collar to provide magnetic attachment between the monitor 100 and the machine 102. In some embodiments, the temperature sensor 110 can be routed to a surface very near the point of contact between the monitor 100 and the machine 102 to provide a more accurate reading of the temperature of the machine 102.

The accelerometer 108 can be a micro-electro-mechanical system (MEMS) accelerometer, capable of one, two, or three axis acceleration data. For example, in some embodiments, the accelerometer 108 can measure forces in three directions along the XYZ axes. The accelerometer 108 can measure and transmit both magnitude and spectral data of the vibrations of a machine 102 to the microcontroller 106.

The microcontroller 106 can be a collection of various components, including computer or computing components. Example components of the microcontroller 106 can include a processor, or a microprocessor, such as a central processing unit (CPU), permanent and impermanent memory, including for example, random access memory (RAM) of various kinds, solid state, flash or other permanent memory, interconnects, buses and communication vias between the various components. In some embodiments, the microcontroller 106 can include external communication circuitry to enable wireless communication, including radio frequency identification (RFID), Bluetooth, cellular, or other communication technologies. In other embodiments the monitor 100 can include dedicated wireless communication circuitry, fabricated or included in the monitor 100, in a separate component than the microcontroller 106.

The monitors 100 can be configured to spend the majority of their time in hibernation state to conserve battery power. In hibernation mode, the power to all or some of the components of the monitor 100 can be reduced or minimized, thereby reducing the overall battery consumption in the hibernation state. The monitors 100 can be configured to periodically exit hibernation mode and enter normal operation mode, where power and functionality to some or all components is restored. For example, the monitors 100 can perform periodic sampling of various operational parameters of the machines 102, such as temperature and vibrations. When scheduled sampling is not performed, the monitors 100 can be in hibernation mode.

The monitors 100 can perform a variety of samplings of machine operation parameters. For example, for the vibration parameter of the machines 102, the monitors 100 can perform various samplings at different intervals and with different characteristics. Example sampling characteristics can include sampling intervals, sampling frequency, sampling rate, sampling range, sampling resolution and other characteristics. Sampling interval can refer to the period by which the monitor 100 turns ON and performs a sampling with a selected set of sampling characteristics. In some embodiments, the monitors 100 can be configured to perform scheduled sampling sessions, which are samplings performed at selected intervals. The selected intervals can depend on the type of machines 102 and other factors that are application-dependent, based on where the monitors 100 are used. Example sampling intervals can include sampling with intervals separated by minutes, hour or hours, days, or even months, and other intervals.

The monitor 100 is a battery-operated device. In most applications extending the longevity of the monitor 100 is proportional to the longevity of the battery module 112. A significant portion of the battery consumption of the monitor 100 relates to the transmission of data to the receiver 103. In some implementations of the described infrastructure, the monitor 100 can compress sensor data, and transmit a compressed data structure to the receiver 103, in order to increase the reliability of transmission and to reduce the battery consumption of the monitor 100. The described embodiments include compression of sensor data, such as vibration data, sensed by the accelerometer 108 and temporarily recorded in a memory device of the monitor 100. Furthermore, the transmission of data between a monitor 100 and a receiver 103 can be constrained by a bandwidth. Efficient compression of data prior to transmission can have the advantage of the monitor 100 being able to collect more data, for example, by collecting smaller samples more frequently. In other words, having an efficient compression algorithm can enable the monitor 100 to increase the frequency of sample collection, relative to a bandwidth constrain. Monitors, not configured with the described compression techniques, may have to reduce their sampling frequency to once per hour, while a monitor 100 configured with the described compression techniques, can collect samples once every three to five minutes.

The described compression techniques can also be selective relevant to machine learning failure analysis techniques, deployed downstream, for example at maintenance 107, or other points in the maintenance suite infrastructure. Compression in the sense of retaining useful data, as determined by the machine learning failure analysis algorithms, and discarding less useful data, is a feature of the described embodiments. In other words, one or more machine learning failure analysis algorithms can be used to finetune which regions and corresponding frequencies in a monitored vibration signal, for a particular industrial machine 102, are useful for returning high-quality, and reliable indicators of failure for that particular industrial machine 102. In some embodiments, a combination of one or more compression techniques can be used, where the extent, degree, or ratio of compression (discarding of the less useful data) can be determined by, or at least in part, based on the output of one or more machine learning algorithms, configured to perform failure analysis and determine regions of interest, more relevant to failure analysis, in a vibration signal.

A vibration signal can be expressed as a superposition of a highly deterministic part, consisting shaft speed harmonics, and a stochastic part, where the main components are natural frequencies and noise. The shaft speed in this region can be related to the rotational speed of the industrial machine 102 upon which the monitor 100 is attached. The natural frequencies and the preliminary shaft speed harmonics can be highly relevant in failure identification. Uncontrolled losses in compressing the natural frequencies and preliminary shaft speed harmonics can negatively impact failure identification algorithms. As a result, sensor data compression techniques can be improved by taking into consideration the nature of the vibration signals. In particular, the vibration signals can include different regions of interests (ROIs) that may be more relevant to failure detection. Maintaining signal quality in those ROIs, when performing compression can improve the reliability and accuracy of failure detection. At the same time, efficient compression can take advantage of the identification of ROIs, by selecting to discard regions that are less relevant to failure analysis when performing compression. For example, the ROIs more relevant to failure analysis can be compressed less aggressively, such that the majority of the original signal data in those ROIs are reliably producible in the decompressed signal. Conversely, the ROIs less relevant to failure analysis can be more aggressively compressed, with higher losses, without fear of losing signal data that could have been highly relevant to failure analysis. Many traditional compression algorithms, such as discrete cosine transform (DCT), throw away or suppress low-energy components of the signal. By contrast, the selective compression used in the described embodiments, can be used to preserve components of the signal that can include data relevant to failure analysis, even if those components are in the low energy portions of the signal.

In some embodiments, at least three ROIs in a vibration signal can be identified. These can include the shaft speed region, the kurtosis region, and the remainder region. These ROIs can be independently compressed, under different regimes, to selectively reduce compression losses in regions more relevant to failure analysis and to improve the reliability of downstream failure detection algorithms. Such failure detection algorithms, in some implementations, can be performed in a cloud infrastructure, or in other hardware or software facilities, independent of the monitor 100 and the receiver 103. In other words, failure detection algorithms, performed downstream, for example, by subcomponents of the maintenance suite 107, can rely on the decompressed vibration signals as received from the receiver 103.

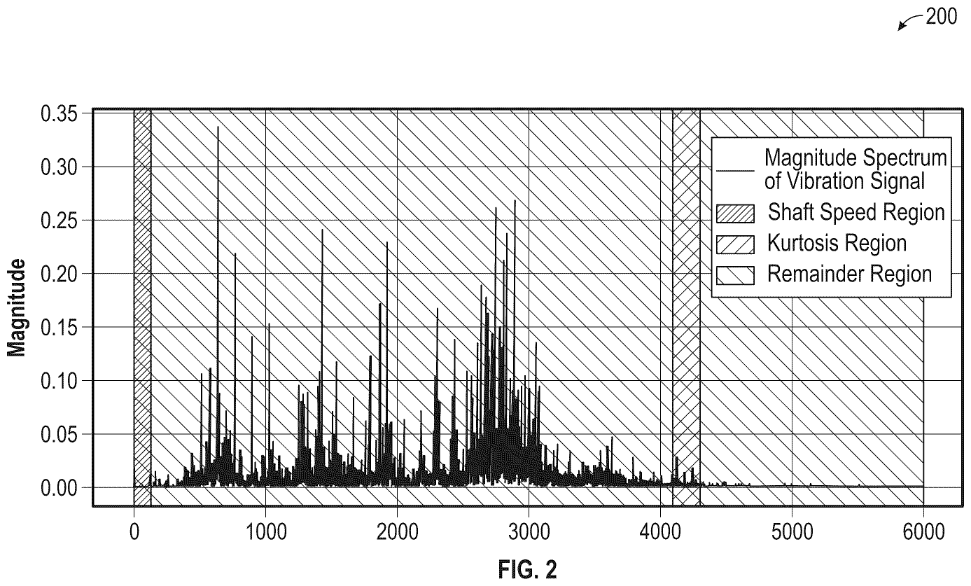

FIG. 2 illustrates a spectrum graph 200 of the magnitude of a sample vibration signal plotted against frequency. The x-axis is the frequency parameter, and the y-axis is the magnitude of the vibration signal. Three regions, shaft speed, kurtosis and remainder regions are also shown. These regions can have different relationships and relevance to potential failures of an industrial machine. For example, the vibration signal in the remainder region can be less relevant to failure analysis than the shaft or kurtosis region, except for peak regions. A compression algorithm tailored to compressing vibration signals can discard more of the data in the remainder region, with the exception of the peaks, than it does in the shaft speed or kurtosis regions. Even within the more relevant regions, like shaft and kurtosis, the compression algorithm can more aggressively retain the data in the peaks, as opposed to other regions.

Shaft speed harmonics are frequencies that are integer multiples of a shaft's rotating speed (e.g., the rotating speed of the industrial machine 102). They can appear in the frequency spectrum of a vibration signal of a machine when there is failure (e.g., looseness), in some components of the machine, which can cause undesirable vibrations. The shaft speed region can be a low-frequency region that can include at least the first three shaft speed harmonics in the interval zero to a maximum frequency ([0, max_freq]. To determine the shaft speed region, the compression algorithm can use Equation (1) to increase the chances of ensuring a selected frequency band can contain the desired K harmonics. For example, in many cases, the frequency band having at least the first three harmonics is preferred.

$$max\_freq = {∅}_{0} \cdot ( K + 0.5 ) \qquad Equation ( 1 )$$

Ø₀ is the shaft speed or fundamental frequency in hertz and K is the number of harmonics.

The kurtosis is a measure of the heaviness of the tails of a distribution (e.g., the distribution of a vibration signal). The kurtosis can help to identify impulsive components or shocks, which can be a failure indicator in vibration analysis. In some embodiments, the shaft speed region can be determined in part by receiving an input shaft speed. In contrast, the natural frequencies may not be easily measured. Kurtosis can be used to spot the relevant natural frequency bands automatically. In some cases, the presence of a high kurtosis can indicate the presence of a machine part failure, for example, a bearing failure, excited in a resonance band.

The kurtosis region of a vibration signal can be identified. The kurtosis region is less less aggressively compressed to increase the chances that high kurtosis information, relevant to determining machine failure (e.g., bearing failure) is maintained for subsequent and downstream failure analysis algorithms. To identify and maintain the kurtosis region, a logarithmically spaced grid can be used to determine a selection of frequency band candidates, and to compute the kurtosis of each candidate. In some embodiments, the maximum kurtosis frequency band can be selected as the “kurtosis” region. The grid has can have as a parameter, the number of frequency band candidates K_{b}, which can be set empirically. For example, in some embodiments, the maximum number of frequency band parameter K_{b} is “32.” The maximum number of frequency band candidates parameter can be empirically determined in relation to a default sampling frequency of the vibration signal. The parameter can be proportionally adjusted for other sampling frequencies. For example a maximum frequency band candidate parameter, K_{b}, “32” can be in relation to a default a sampling frequency of 16 kHz. When a lower sampling frequency is used, a lower K_{b} value can be used, where the K_{b} value is adjusted in the same proportion as the difference in the sampling frequencies. For example, when the sampling frequency is 8 kHz, the K_{b}=16 or lower can be used. The same applies for circumstances when the sampling frequency is increased.

The remainder region can be determined after identifying the shaft speed and kurtosis regions by subtracting the two regions from the original signal.

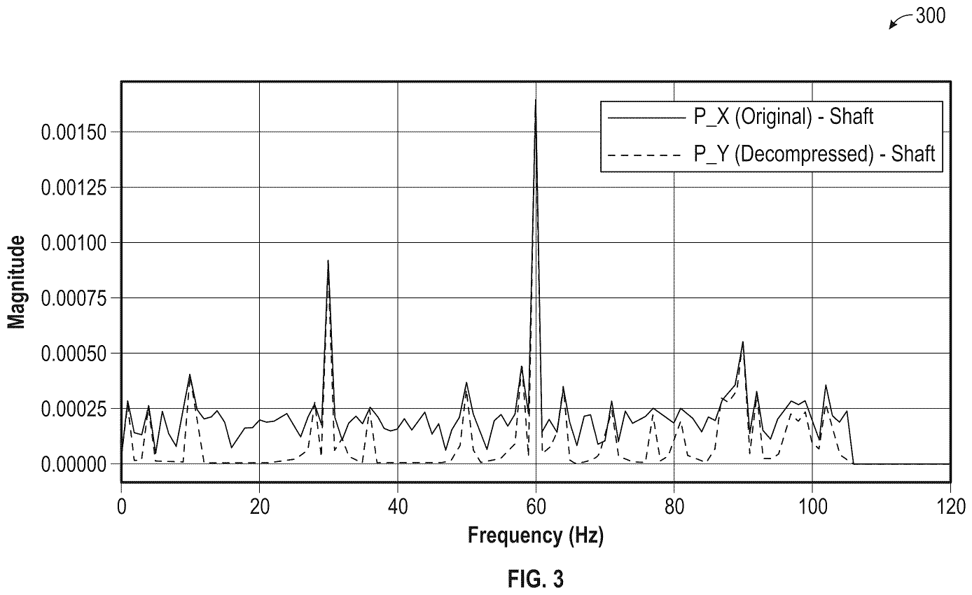

FIG. 3 illustrates a graph 300 of a magnitude spectrum of a vibration signal in the shaft speed region, comparing the decompressed version of the vibration signal to its original vibration signal in the shaft speed region. In other words, the graph 300 visually illustrates the amount of data discarded or lost in the shaft speed region, when applying the described compression techniques to a vibration signal. The x-axis is frequency. The y-axis is magnitude. The decompressed signal retains the original vibration signal data more aggressively in the peak regions. The peak regions can be more indicative of a failure. Having robust data in these regions can help the downstream failure analysis algorithms.

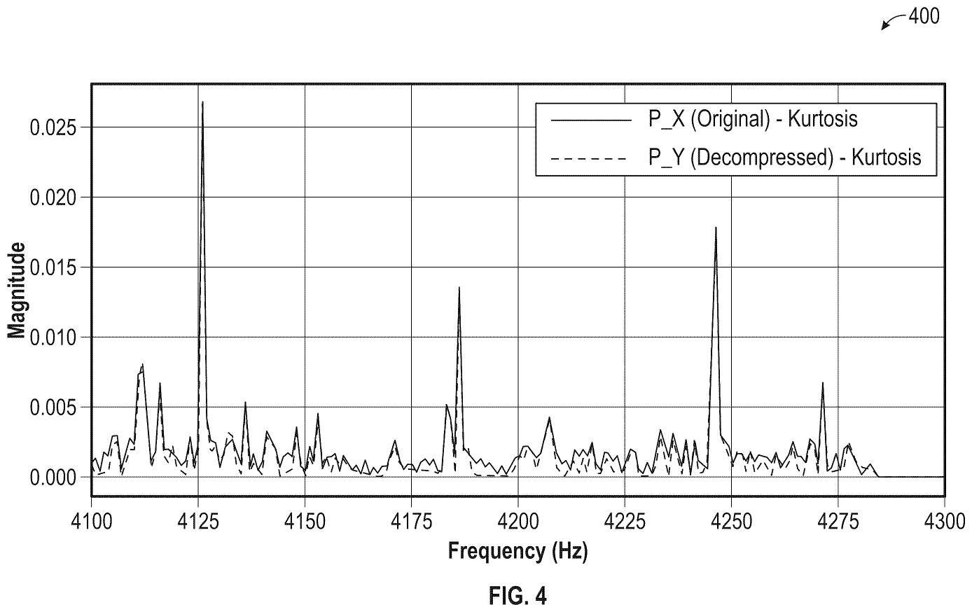

FIG. 4 illustrates a graph 400 of a magnitude spectrum of a vibration signal in the kurtosis region, comparing the decompressed version of the vibration signal to its original vibration signal in the kurtosis region. In other words, the graph 400 visually illustrates the amount of data discarded or lost in the kurtosis region, when applying the described compression techniques to a vibration signal. The x-axis is frequency. The y-axis is magnitude. In the kurtosis region, the decompressed signal retains the original vibration signal data more aggressively, and in more regions than just the peak regions, as the kurtosis region can include more data indicative of machine component failures. As having more robust data in the kurtosis region is useful for failure analysis, the described compression techniques retain more of the original signal in the kurtosis region.

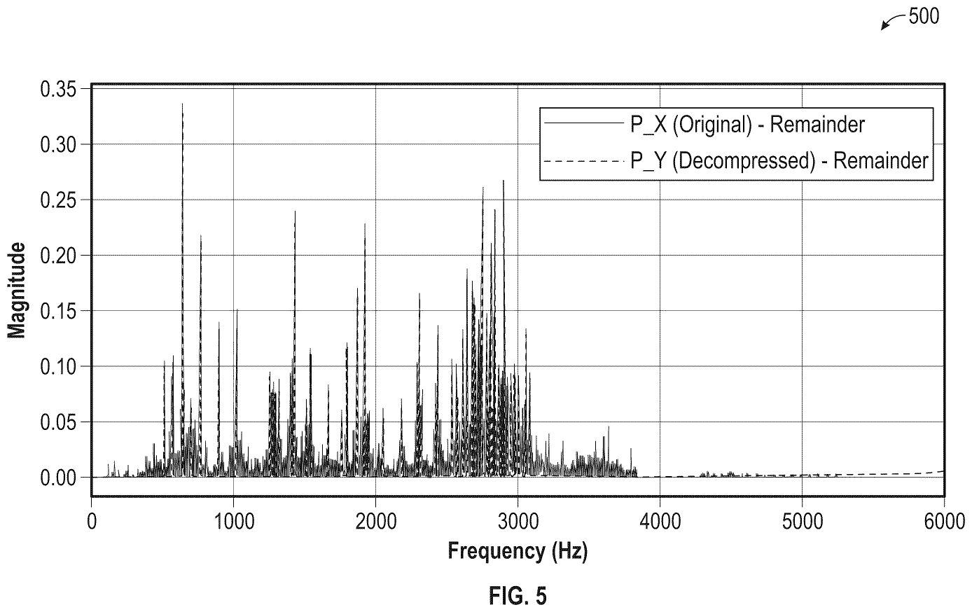

FIG. 5 illustrates a graph 500 of a magnitude spectrum of a vibration signal in the remainder region, comparing the decompressed version of the vibration signal to its original vibration signal in the remainder region. In other words, the graph 500 visually illustrates the amount of data discarded or lost in the remainder region, when applying the described compression techniques to a vibration signal. The x-axis is frequency. The y-axis is magnitude. In the remainder region, the decompressed signal discards much of the original signal, except in the peaks and in the peaks regions. As the remainder region does not typically include much data relevant to the failure analysis, except in the peaks and peak regions, the data in the remainder region can be more aggressively discarded, or compressed with a lossy algorithm, with less or minimal impact on the downstream failure analysis algorithms.

The compression rate, which is a measure of the percentage of the original signal retained when performing compression is somewhat exaggerated in the graphs 300-500, in order to, more prominently and visually, highlight the differences between the decompressed and original signals in various regions of interest. In practice, the compression rate can vary, depending on the type and complexity of the industrial machines 102, and/or their maintenance and profile history. In some embodiments, the compression rate can be empirically determined. In other embodiments, an AI-based approach, finding an optimum compression rate can be utilized. In other embodiments, a combination of these techniques can be used to determine an optimum compression rate. Compression rate, in the context of the described embodiments, can also refer to the percentage of energy of the original signal that is maintained in the compressed signal. In this respect, the compression rate, in the kurtosis region, is selected to retain more energy in the compressed signal, relative to the original signal.

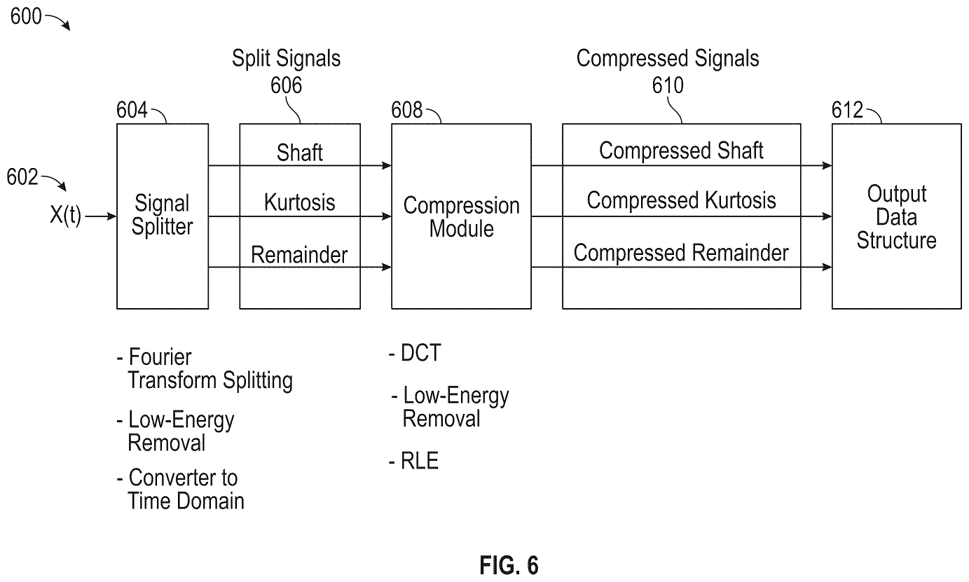

FIG. 6 illustrates an example block diagram of a codec 600 that implements a compression technique, according to some embodiments. An original signal 602 is processed by a signal splitter 604. The signal splitter 604 can be implemented by a microprocessor or a microcontroller, such as the microcontroller 106. The original signal 602 can be a vibration signal in time domain, obtained from sensor, such as the accelerometer 108. The signal splitter 604 performs operations, including performing Fourier transform, ROI identification, and low-energy signal removal on the original signal 602. In some embodiments, the signal splitter 604 performs Fourier transform on the original signal 602, transforming the original signal to a spectrum in frequency domain.

The signal splitter 604 can apply one or more binary masks or filters to the spectrum by selecting a high-energy threshold and a corresponding high-energy frequency threshold. By applying the mask, the signal splitter 604 maintains spectrum frequencies above the high-energy threshold and discards the spectrum frequencies below the high-energy threshold. The masking/filtering is applied in frequency domain to the spectrum of the original signal 602. The higher-energy signal components or portions inside the make are selected and maintained. The high-energy threshold represents the percentage of the energy of the spectrum of the original signal to be maintained in the compressed signal.

The signal splitter 604 can determine various ROIs, including the shaft speed region, the kurtosis region and the remainder region. The shaft speed region in the spectrum can be determined, based on receiving an input of the shaft speed, or a rotational speed of the industrial machine 102 to which the monitor 100 is attached. As described earlier, the shaft speed region is a region that includes at least a selected number of initial harmonics in the range [0, max-freq]. The signal splitter can utilize the Equation (1) to determine the shaft speed region.

The signal splitter 604 can determine a kurtosis region by performing operations, such as using a logarithmically spaced grid to determine a selection of frequency band candidates, calculating the kurtosis of each candidate, and selecting the frequency band candidate, having the maximum kurtosis, as the kurtosis region. The signal splitter 604 can utilize the frequency band candidate parameter K_{b}, as described earlier.

After determining the shaft and kurtosis regions, the signal splitter 604 can determine the remainder region by subtracting the shaft and kurtosis regions from the original signal. The signal splitter 604 can include a time domain converter that converts each ROIs, shaft, kurtosis and remainder, to the time domain. The signal splitter 604, outputs the time domain split signals 606, which can include the shaft, kurtosis and remainder regions in time domain. In some embodiments, the time domain converter can be implemented, using inverse Fourier transform operations.

A compression module 608 can receive the time domain split signals 606 and can independently compress them. In this manner, the compression module 608 can apply different compression rates to each split signal, depending on the split signals relevance and importance to downstream machine failure analysis. The compression module 608 can use a variety of compression algorithms and can adjust the compression parameters, to increase or decrease the degree of the information retained from the original split signal, based on the degree of relevance and importance of that split signal to downstream failure analysis algorithms. For example, the compression module 608, may use a lossy compression algorithm for compressing the remainder region split signal. The compression algorithm used for the kurtosis region can be more conservative and aim to reduce losses of the original kurtosis split signal in the compression. An example compression algorithm that may be used by the compression module 608 can include discrete cosine transform (DCT). The compression module 608 can also perform low-energy component removal, to further discard the portions of the original signal 602 that are less relevant to failure analysis. In some embodiments, the compression module 608 can also selectively or collectively apply additional compression algorithms to one or more split signals 606. For example, the compression module 608 can apply a run-length encoding (RLE) algorithm to one or more split signals or compressed split signals.

Compression module 608 outputs independent compressed signals 610, including for example compressed shaft signal, compressed kurtosis signal and compressed remainder signal. The compressed signals 610 can be assembled in an output data structure 612. For example, the output data structure 612 can be a Python dictionary, but any data structure that can assemble and pack the compressed signals 610 can be used.

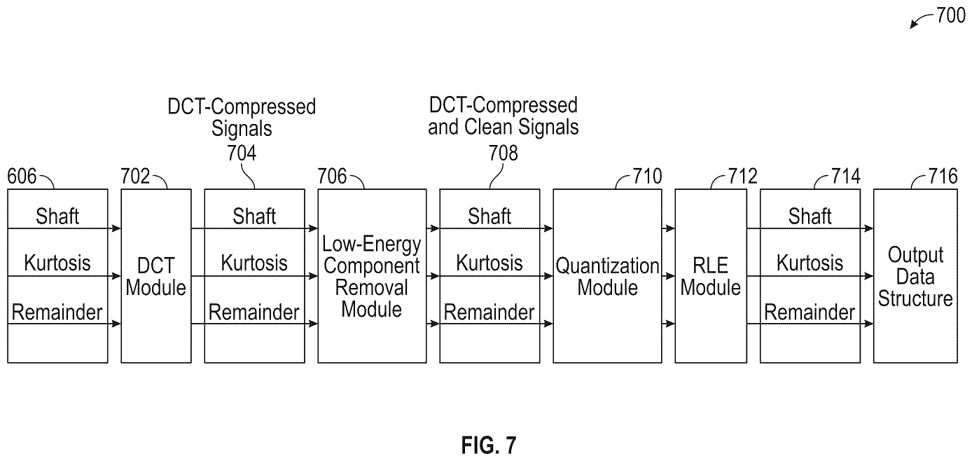

FIG. 7 illustrates an example block diagram of a compression module 700, according to an embodiment. The compression module 700 can be an example implementation of the compression module 608. The split signals 606, from the signal splitter 604 can be received at a DCT module 702. The split signals 606 can include shaft, kurtosis and remainder signals. The DCT module 702 can independently and/or selectively apply a discrete cosine transform (DCT) to one or more split signals 606, generating DCT-compressed signals 704. A low-energy component removal module 706 can independently and/or selectively extract the low-energy components of the DCT-compressed signals 704, generating the DCT-compressed and clean signals 708. The low-energy component removal module 706 can operate in the same manner as described above, in relation to the embodiment of FIG. 6 and the low-energy component removal performed by the signal splitter 604. In some embodiments, the low-energy component removal module retains 68% of the DCT-compressed signals 704. In some embodiments, a quantization module 710 can be used to quantify the signals. For example, an 8-bit quantization can be used. An RLE module 712 can apply run-length encoding (RLE) to the signals to decrease the chances of transmitting unnecessary zero values in any of the signals, generating the RLE-encoded signals 714. The RLE encoded signals 714 can be used to assemble the output data structure 716. The monitor 100 can transmit the output data structure 716 to the receiver 103.

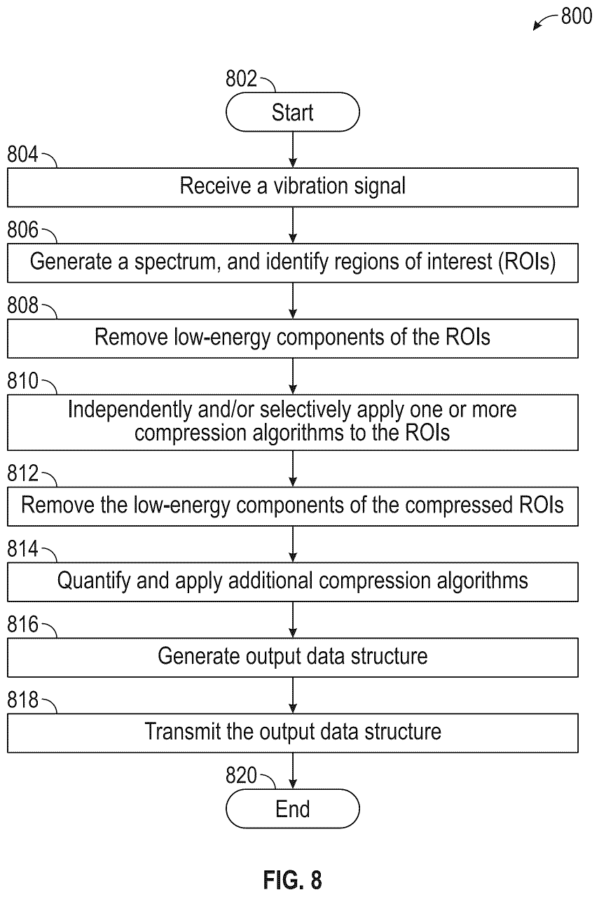

FIG. 8 illustrates an example flowchart of a compression method 800, according to an embodiment. The method starts at step 802. At step 804, a signal from a sensor of the monitor 100 is received. As an example, the signal can be a vibration signal, received from the accelerometer 108. In some embodiments, the microcontroller 106 can perform additional processing to generate the signal from raw sensor data. For example, the accelerometer 108 can output raw accelerometer data, which the microcontroller 106 can turn into a vibration signal. The signal received at step 804 is in time domain. While the remaining steps of the method 800 is described in relation to a vibration signal, other signals from other sensors of the monitor 100 can also be compressed, using the described technology. At step 806, a spectrum signal is generated by converting the vibration signal from time domain to frequency domain. For example, the microcontroller 106 can perform a Fourier Transform (FT) operation to convert the vibration signal from time domain to frequency domain. Step 806 additionally includes identifying regions of interests (ROIs), relative to a type of failure analysis. For example, for bearing failure, regions of interest can include shaft speed region, kurtosis region and the remainder region. One or more downstream failure analysis machine learning models can be used in a feedback loop, with the method 800 and the step 806 (identifying the failure-related ROIs) to improve the identification of relevant ROIs.

At step 808, low-energy components of the ROIs are removed. The low-energy components can have less relevance to a downstream failure analysis, while spikes and peaks and regions near spikes and peaks can have more relevance in identifying potential failures in the industrial machines 102. Step 810, includes independently and/or selectively applying one or more compression algorithms, such as a discrete cosine transform (DCT) to the ROIs. In other words, each region of interest may be treated or compressed with a different compression algorithm or with some common compression algorithms, but with different compression parameters. Independent application of the compression algorithms allows for retention of more of the ROI, if the ROI is relevant to downstream failure analysis, and discarding more of the data, thereby achieving a more compact output, if the ROI is of less relevance to the downstream failure analysis.

Step 812 includes further removing low-energy components of the compressed ROIs, obtained at step 810. Step 814 includes quantifying and applying additional compression algorithms to further remove unnecessary or less relevant data from the previously compressed ROIs. For example, in some embodiments, a run-length encoding (RLE) compression algorithm can be applied to further compress the data prior to transmission. RLE, in particular, removes unnecessary strings of zeros from the compressed signal, which can increase the efficiency of the transfer of data, improve the battery-life of the monitor 100, without or with minimal loss of the original signal.

AT step 816, an output data structure is generated, based on the quantified and compressed signal. At step 818, the monitor 100 can wirelessly transmit the output data structure to a receiver 103, using a transmitter or transceiver. The method ends at step 820.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

### EXAMPLES

It will be appreciated that the present disclosure may include any one and up to all of the following examples.

Example 1: A method comprising: with a monitor, comprising a battery, a printed circuit board (PCB), a microprocessor embedded on the PCB, a transmitter embedded on the PCB, and an accelerometer embedded on the PCB, the monitor attached to a machine, the machine producing machine vibrations, receiving the machine vibrations with the accelerometer; generating, with the microprocessor, a vibration signal, based at least in part on the received machine vibrations from the accelerometer; with the microprocessor, determining regions of interests in the vibration signal; compressing each region of interest, independently than the other regions of interest, generating a plurality of compressed signals; and generating a plurality of transformed compressed signals, by removing low-energy components from each compressed signal, wherein low-energy components comprise portions of the compressed signal, having an energy below a selected threshold; transmitting, by the transmitter embedded on the PCB, the plurality of the transformed compressed signals.

Example 2: The method of Example 1, further comprising: assembling the transformed compressed signals into a selected data structure, wherein transmitting the plurality of the transformed compressed signals, comprises transmitting the data structure.

Example 3: The method of some or all of Examples 1 and 2, wherein the regions of interest comprise a shaft speed region, a kurtosis region, and a remainder region.

Example 4: The method of some or all of Examples 1-3, wherein the regions of interest comprise a shaft speed region, determined, based on receiving an input comprising a shaft speed frequency of the machine.

Example 5: The method of some or all of Examples 1-4, wherein the regions of interest comprise a kurtosis region, determined by performing operations comprising: with a logarithmically spaced grid, determining frequency band candidates; calculating kurtosis of each frequency band candidate; and selecting the frequency band, having the maximum kurtosis as the kurtosis region.

Example 6: The method of some or all of Examples 1-5, wherein the grid comprises a maximum number of frequency band candidates, determined empirically.

Example 7: The method of some or all of Examples 1-6, wherein the maximum number of frequency band candidates are empirically determined for a default sampling frequency, and subsequent maximum number of frequency band candidates for a sampling frequency are adjusted proportionally, relative to the default sampling frequency.

Example 8: The method of some or all of Examples 1-7, wherein the regions of interest comprise a shaft speed region, a kurtosis region, and a remainder region, and the remainder region is determined by subtracting the shaft speed region and the kurtosis region from the vibration signal.

Example 9: The method of some or all of Examples 1-8, further comprising: the microprocessor of the monitor, performing a Fourier transform, transforming the vibration signal to a spectrum; the microprocessor of the monitor, applying one or more binary masks to the spectrum; the microprocessor of the monitor, for a binary mask, selecting a high-energy threshold and a corresponding high-energy frequency threshold; and the microprocessor, applying the mask, maintaining spectrum frequencies above the high-energy frequency threshold, and discarding the spectrum frequencies below the high-energy frequency threshold.

Example 10: The method of some or all of Examples 1-10, further comprising: a receiver, receiving the plurality of the transformed compressed signals; the receiver, having a receiver microprocessor, coupled to a receiver memory, decompressing, with the receiver microprocessor, the transformed compressed signals, generating decompressed signals at the receiver; and the receiver microprocessor, regenerating the vibration signal, based at least in part on the decompressed signals.

Example 11: A maintenance monitoring system comprising, a monitor, and a receiver, the monitor comprising a battery, a printed circuit board (PCB), a microprocessor embedded on the PCB, a transmitter embedded on the PCB, and an accelerometer embedded on the PCB, the monitor attached to a machine, the machine producing machine vibrations, wherein the monitor is configured to perform operations comprising: receiving the machine vibrations with the accelerometer; generating, with the microprocessor, a vibration signal, based at least in part on the received machine vibrations from the accelerometer; with the microprocessor, determining regions of interests in the vibration signal; compressing each region of interest, independently than the other regions of interest, generating a plurality of compressed signals; and generating a plurality of transformed compressed signals, by removing low-energy components from each compressed signal, wherein low-energy components comprise portions of the compressed signal, having an energy below a selected threshold; transmitting, by the transmitter embedded on the PCB, the plurality of the transformed compressed signals.

Example 12: The system of Example 11, wherein the operations further comprise assembling the transformed compressed signals into a selected data structure, wherein transmitting the plurality of the transformed compressed signals, comprises transmitting the data structure.

Example 13: The system of some or all of Examples 11 and 12, wherein the regions of interest comprise a shaft speed region, a kurtosis region, and a remainder region.

Example 14: The system of some or all of Examples 11-13, wherein the regions of interest comprise a shaft speed region, determined, based on receiving an input comprising a shaft speed frequency of the machine.

Example 15: The system of some or all of Examples 11-14, wherein the regions of interest comprise a kurtosis region, determined by performing additional operations comprising: with a logarithmically spaced grid, determining frequency band candidates; calculating kurtosis of each frequency band candidate; and selecting the frequency band, having the maximum kurtosis as the kurtosis region.

Example 16: The system of some or all of Examples 11-15, wherein the grid comprises a maximum number of frequency band candidates, determined empirically.

Example 17: The system of some or all of Examples 11-16, wherein the maximum number of frequency band candidates are empirically determined for a default sampling frequency, and subsequent maximum number of frequency band candidates for a sampling frequency are adjusted proportionally, relative to the default sampling frequency.

Example 18: The system of some or all of Examples 11-17, wherein the regions of interest comprise a shaft speed region, a kurtosis region, and a remainder region, and the remainder region is determined by subtracting the shaft speed region and the kurtosis region from the vibration signal.

Example 19: The system of some or all of Examples 11-18, wherein the operations further comprise: the microprocessor of the monitor, performing a Fourier transform, transforming the vibration signal to a spectrum; the microprocessor of the monitor, applying one or more binary masks to the spectrum; the microprocessor of the monitor, for a binary mask, selecting a high-energy threshold and a corresponding high-energy frequency threshold; and the microprocessor, applying the mask, maintaining spectrum frequencies above the high-energy frequency threshold, and discarding the spectrum frequencies below the high-energy frequency threshold.

Example 20: The system of some or all of Examples 11-19, wherein the operations further comprise: the receiver, receiving the plurality of the transformed compressed signals; the receiver, having a receiver microprocessor, coupled to a receiver memory, decompressing, with the receiver microprocessor, the transformed compressed signals, generating decompressed signals at the receiver; and the receiver microprocessor, regenerating the vibration signal, based at least in part on the decompressed signals.

1. A method of conserving the battery of a battery-operated wireless portable monitor, the method comprising:
wherein the monitor is removably attachable to an industrial machine in a plant, the monitor comprising a wireless communication module,
the monitor wirelessly communicating machine vibration data to a receiver, the receiver communicating the machine vibration data to an upstream server of a maintenance infrastructure;
wherein the monitor, comprising a battery, a printed circuit board (PCB), a microprocessor embedded on the PCB, a transmitter embedded on the PCB, and an accelerometer embedded on the PCB, and the monitor attached to the machine, the machine producing machine vibrations, the monitor receiving the machine vibrations with the accelerometer;
the monitor compressing the machine vibrations before wirelessly transmitting the machine vibrations to the receiver, thereby conserving the battery of the monitor, wherein the compressing further comprises:
generating, with the microprocessor, a vibration signal, based at least in part on the received machine vibrations from the accelerometer;
with the microprocessor, determining regions of interests in the vibration signal;
compressing each region of interest, independently than the other regions of interest, generating a plurality of compressed signals; and
generating a plurality of transformed compressed signals, by removing low-energy components from each compressed signal, wherein low-energy components comprise portions of the compressed signal, having an energy below a selected threshold;
transmitting, by the transmitter embedded on the PCB, the plurality of the transformed compressed signals to the receiver of the maintenance infrastructure;
the receiver transmitting the compressed signals to one or more upstream servers of the maintenance infrastructure;
the maintenance infrastructure, comprising one or more artificial intelligence submodules, configured to perform fault prediction, predicting the likelihood of one or more machine failures, based at least in part on the received compressed signals.

2. The method of claim 1, further comprising: assembling the transformed compressed signals into a selected data structure, wherein transmitting the plurality of the transformed compressed signals, comprises transmitting the data structure.

3. The method of claim 1, wherein the regions of interest comprise a shaft speed region, a kurtosis region, and a remainder region.

4. The method of claim 1, wherein the regions of interest comprise a shaft speed region, determined, based on receiving an input comprising a shaft speed frequency of the machine.

5. The method of claim 1, wherein the regions of interest comprise a kurtosis region, determined by performing operations comprising:
with a logarithmically spaced grid, determining frequency band candidates;
calculating kurtosis of each frequency band candidate; and
selecting the frequency band, having the maximum kurtosis as the kurtosis region.

6. The method of claim 5, wherein the grid comprises a maximum number of frequency band candidates, determined empirically.

7. The method of claim 5, wherein the maximum number of frequency band candidates are empirically determined for a default sampling frequency, and subsequent maximum number of frequency band candidates for a sampling frequency are adjusted proportionally, relative to the default sampling frequency.

8. The method of claim 1, wherein the regions of interest comprise a shaft speed region, a kurtosis region, and a remainder region, and the remainder region is determined by subtracting the shaft speed region and the kurtosis region from the vibration signal.

9. The method of claim 1, further comprising:
the microprocessor of the monitor, performing a Fourier transform, transforming the vibration signal to a spectrum;
the microprocessor of the monitor, applying one or more binary masks to the spectrum;
the microprocessor of the monitor, for a binary mask, selecting a high-energy threshold and a corresponding high-energy frequency threshold; and
the microprocessor, applying the mask, maintaining spectrum frequencies above the high-energy frequency threshold, and discarding the spectrum frequencies below the high-energy frequency threshold.

10. The method of claim 1, further comprising:
the receiver, receiving the plurality of the transformed compressed signals;
the receiver, having a receiver microprocessor, coupled to a receiver memory, decompressing, with the receiver microprocessor, the transformed compressed signals, generating decompressed signals at the receiver; and
the receiver microprocessor, regenerating the vibration signal, based at least in part on the decompressed signals.

11. A maintenance monitoring system comprising, a monitor, and a receiver,
the monitor removably attachable to an industrial machine in a plant, the monitor comprising a wireless communication module, the monitor wirelessly communicating machine vibration data to a receiver, the receiver communicating the machine vibration data to an upstream server of a maintenance infrastructure,
the monitor comprising a battery, a printed circuit board (PCB), a microprocessor embedded on the PCB, a transmitter embedded on the PCB, and an accelerometer embedded on the PCB, the monitor attached to a machine, the machine producing machine vibrations, wherein the monitor is configured to perform operations comprising:
receiving the machine vibrations with the accelerometer;
compressing the machine vibrations before wirelessly transmitting the machine vibrations to the receiver, thereby conserving the battery of the monitor, wherein the compressing further comprises:
generating, with the microprocessor, a vibration signal, based at least in part on the received machine vibrations from the accelerometer;
with the microprocessor, determining regions of interests in the vibration signal;
compressing each region of interest, independently than the other regions of interest, generating a plurality of compressed signals; and
generating a plurality of transformed compressed signals, by removing low-energy components from each compressed signal, wherein low-energy components comprise portions of the compressed signal, having an energy below a selected threshold;
transmitting, by the transmitter embedded on the PCB, the plurality of the transformed compressed signals to the receiver of the maintenance infrastructure;
the receiver transmitting the compressed signals to one or more upstream servers of the maintenance infrastructure;
the maintenance infrastructure, comprising one or more artificial intelligence submodules, configured to perform fault prediction, predicting the likelihood of one or more machine failures, based at least in part on the received compressed signals.

12. The system of claim 11, wherein the operations further comprise assembling the transformed compressed signals into a selected data structure, wherein transmitting the plurality of the transformed compressed signals, comprises transmitting the data structure.

13. The system of claim 11, wherein the regions of interest comprise a shaft speed region, a kurtosis region, and a remainder region.

14. The system of claim 11, wherein the regions of interest comprise a shaft speed region, determined, based on receiving an input comprising a shaft speed frequency of the machine.

15. The system of claim 11, wherein the regions of interest comprise a kurtosis region, determined by performing additional operations comprising:
with a logarithmically spaced grid, determining frequency band candidates;
calculating kurtosis of each frequency band candidate; and
selecting the frequency band, having the maximum kurtosis as the kurtosis region.

16. The system of claim 15, wherein the grid comprises a maximum number of frequency band candidates, determined empirically.

17. The system of claim 15, wherein the maximum number of frequency band candidates are empirically determined for a default sampling frequency, and subsequent maximum number of frequency band candidates for a sampling frequency are adjusted proportionally, relative to the default sampling frequency.

18. The system of claim 11, wherein the regions of interest comprise a shaft speed region, a kurtosis region, and a remainder region, and the remainder region is determined by subtracting the shaft speed region and the kurtosis region from the vibration signal.

19. The system of claim 11, wherein the operations further comprise:
the microprocessor of the monitor, performing a Fourier transform, transforming the vibration signal to a spectrum;
the microprocessor of the monitor, applying one or more binary masks to the spectrum;
the microprocessor of the monitor, for a binary mask, selecting a high-energy threshold and a corresponding high-energy frequency threshold; and
the microprocessor, applying the mask, maintaining spectrum frequencies above the high-energy frequency threshold, and discarding the spectrum frequencies below the high-energy frequency threshold.

20. The system of claim 11, wherein the operations further comprise:
the receiver, receiving the plurality of the transformed compressed signals;
the receiver, having a receiver microprocessor, coupled to a receiver memory, decompressing, with the receiver microprocessor, the transformed compressed signals, generating decompressed signals at the receiver; and
the receiver microprocessor, regenerating the vibration signal, based at least in part on the decompressed signals.
